(19) United States
(12) Patent Application Publication
(10) Pub. No.: US 2007/0023257 A1
(43) Pub. Date: Feb. 1, 2007

(54) Breakaway conveyor discharge

(76) Inventor: Ricardo N. Schiesser, Ada, MI (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 11/458,569

(22) Filed: Jul. 19, 2006

Related U.S. Application Data
(60) Provisional application No. 60/703,269, filed on Jul. 28, 2005.

(51) Int. Cl. B65G 47/46

(52) U.S. Cl. 198/370.04; 198/539

(57) ABSTRACT

A breakaway conveyor discharge member received between first and second conveying surfaces is provided. The conveyor discharge member is received by a bracket mounted on a frame connected between the first and second conveying surfaces. The conveyor discharge member includes a generally planar surface between the first and second conveying surfaces. The conveyor discharge member can withstand a vertical load substantially greater than a particular longitudinal load on the planar surface. Under normal operating conditions, the conveyor discharge member conveys the object from the first conveyor surface onto the intake conveying surface. Under jam conditions, when the substantially longitudinal load is great enough, the conveyor discharge member dislodges from the brackets to protect the first and second conveying surfaces by eliminating the jam point.

### CROSS REFERENCE TO RELATED APPLICATION

This application claims priority from U.S. provisional patent application Ser. No. 60/703,269, filed on Jul. 28, 2005, the disclosure of which is hereby incorporated herein by reference in its entirety.

### BACKGROUND OF THE PRESENT INVENTION

The present invention pertains to a conveyor system and more particularly to a conveyor discharge, or transition section, received between a discharge conveying surface and an intake conveying surface.

Conventional slat conveyor systems often consist of conveyor beds with large radius sprockets or wheel guides at the charge end and the discharge end. These large sprockets or wheel guides often impart a large radius of curvature to the slat web thereby forming rounded ends and producing a substantial gap between a discharge conveying surface and the adjacent charge conveying surface. Accordingly, a transition surface may be required to compensate for the large radius of curvature of the rounded ends between the two conveying surfaces. A transition plate is often placed in this transition gap to assist in the smooth transition of conveyed objects between the two conveying surfaces. Conventional transition plates are often mounted between two conveying surfaces to provide a stationary planar transition surface.

However, even with transition plates placed between tandem conveying surfaces, jamming of packages may occur in the gap area between the transition plate and the discharge conveying surface. Jams may result from objects protruding from conveyed packages which may catch in this gap area. Moreover, the discharge conveying surface may move at a high rate of speed, for example as with a positive displacement sorter. Thus, when jams occur at such a high rate of speed, conveyed objects may be damaged, subsequent objects may slam into jammed objects, and the conveyors may also be damaged.

Accordingly, there is a need for an improvement to conventional transition plates or gap plates between two conveying surfaces to help prevent jams and reduce the likelihood of damage to packages and conveyors.

### SUMMARY OF THE INVENTION

The present invention provides a breakaway conveyor discharge member which mitigates the above-discussed difficulties.

According to one aspect of the present invention, a conveyor system is provided. The conveyor system includes first and second conveying surfaces conveying objects in a longitudinal direction and defining a gap at a transition between the conveying surfaces with a conveyor discharge member at the gap. The conveyor discharge includes a plate defining a generally planar surface between the conveying surfaces. The conveyor discharge member is movable in response to a particular longitudinal force to reduce jam locations between the conveyor discharge member and the conveying surfaces.

According to another embodiment of the present invention, a conveyor system is provided. The conveyor system includes first and second conveying surfaces conveying objects in a longitudinal direction and defining a gap at a transition between the conveying surfaces with a conveyor discharge member at the gap. The conveyor discharge member provides a generally planar surface between the conveying surfaces. The conveyor discharge member supports up to a particular vertical force upon the conveyor discharge member. The conveyor discharge member breaks away in response to a particular longitudinal force upon the conveyor discharge member, where the particular vertical force is greater than the particular longitudinal force.

In one form of the present invention, a conveyor system is provided. The conveyor system includes a discharge conveyor, an intake conveyor, a frame connected between the conveyors, a pair of brackets received on opposite sides of the frame and a conveyor discharge member supported by the brackets. The conveyor discharge member includes a plate providing a substantially planar surface between the conveyors. The conveyor discharge member dislodges from the bracket when an object enters an area between the discharge conveyor and the conveyor discharge member creating a particular longitudinal force upon the conveyor discharge member.

In another form of the present invention, a method for reducing jams of an object between first and a second conveying surfaces is provided. The method includes receiving a conveyor discharge member between the first and second conveying surfaces providing a planar surface between the first conveying surface and the second conveying surface and dislodging the conveyor discharge member from between the first and second conveying surfaces in response to a particular longitudinal force applied in an area of the first conveying surface and the conveyor discharge member.

Therefore, the present invention provides a conveyor system including a conveyor discharge member between first and second conveying surfaces. The conveyor system includes a conveyor discharge member received by a frame, which is connected between the conveying surfaces. The discharge conveyor member provides a generally planar surface between the first and second conveying surfaces and supports a substantial vertical load, such as the weight of a person. When a conveyed object creates a sufficiently strong longitudinal force upon the conveyor discharge member, it is assumed to be a package jam, and the conveyor discharge member dislodges from a set of brackets mounted on the frame to reduce the likelihood of damage. When the conveyor discharge member dislodges from the brackets, the first conveying surface may be halted to prevent any damage to the conveyed objects or conveying surfaces.

These and other objects, advantages, purposes, and features of the present invention will become apparent upon review of the specification in conjunction with the drawings.

### BRIEF DESCRIPTION OF THE DRAWINGS

FIG. 1 is a top perspective view of the breakaway conveyor discharge between first and second conveying surfaces, in accordance with the present invention;

FIG. 2 is a top perspective view of the conveyor discharge member of FIG. 1 in an upward angled position;

FIG. 3 is a top perspective view of the conveyor discharge member of the present invention;

FIG. 4 is a bottom perspective view of the conveyor discharge member of FIG. 3;

FIG. 5 is a side elevation of the conveyor discharge member engaged with the bracket in a base position of the present invention;

FIG. 6 is a side elevation of the bracket and conveyor discharge member of FIG. 5 in a dislodged position;

FIG. 7 is the same view as FIG. 5 of an alternative embodiment;

FIG. 8 is a side elevation of the bracket and conveyor discharge member of FIG. 8 in a dislodged position with the retainer broken;

FIG. 9 is the same view as FIG. 1 of another alternative embodiment;

FIG. 10 is the same view as FIG. 5 of an alternative embodiment; and

FIG. 11 is a side elevation of the bracket and conveyor discharge member of FIG. 10 in a dislodged position.

### DETAILED DESCRIPTION OF THE PREFERRED EMBODIMENTS

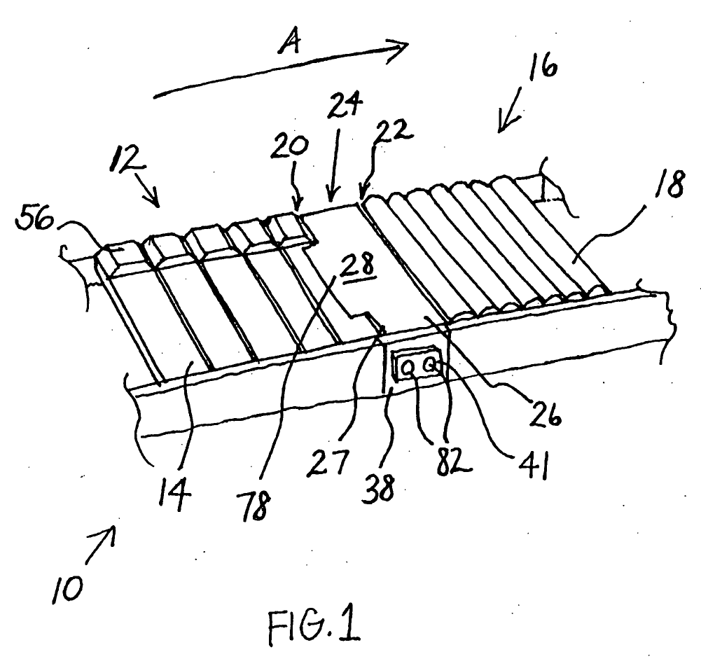

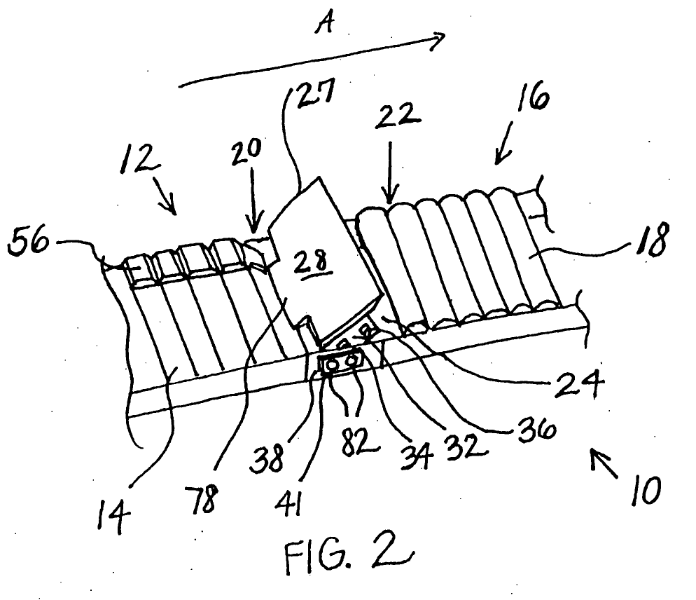

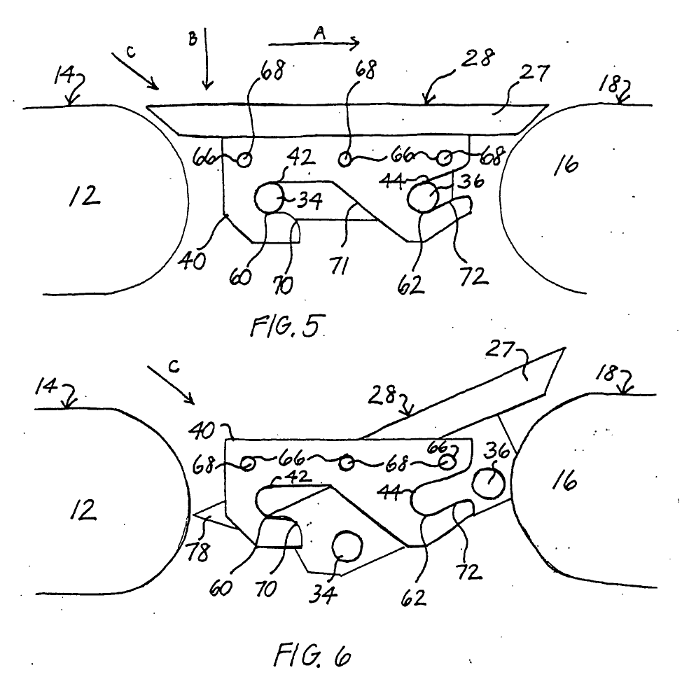

Referring now to the figures, a conveyor system 10 includes a first conveyor system 12 with a first slat conveying surface 14 and a second conveyor system 16 with a second conveying surface 18, as best illustrated in FIGS. 1 and 2. First conveying surface 14 includes a discharge end 20 and second conveying surfaces includes a charge end 22. Discharge end 20 and charge end 22 may both have a large radius of curvature due to sprockets or pulleys at each end with a large radius. When adjacent discharge end 20 and charge end 22 are placed in tandem or in series, the ends may form a non-planar gap 24 between conveying surfaces 14, 18. A conveyor discharge member 26 is placed in gap 24 to provide a generally planar surface 28 for smooth transitioning of conveyed objects in a longitudinal direction, A, between conveying surfaces 14, 18, as best illustrated in FIG. 1. Conveyor discharge member 26, which may also be referred to as a breakaway conveyor discharge member, is able to withstand a substantial vertical load or force B (FIG. 5) greater than a particular longitudinal load, C (FIG. 5). Additionally, conveyor discharge member 26 is operable for sliding or moving into a dislodged position (FIGS. 2 and 6) discharging or dislodging or breaking away from gap 24, as will be discussed further below.

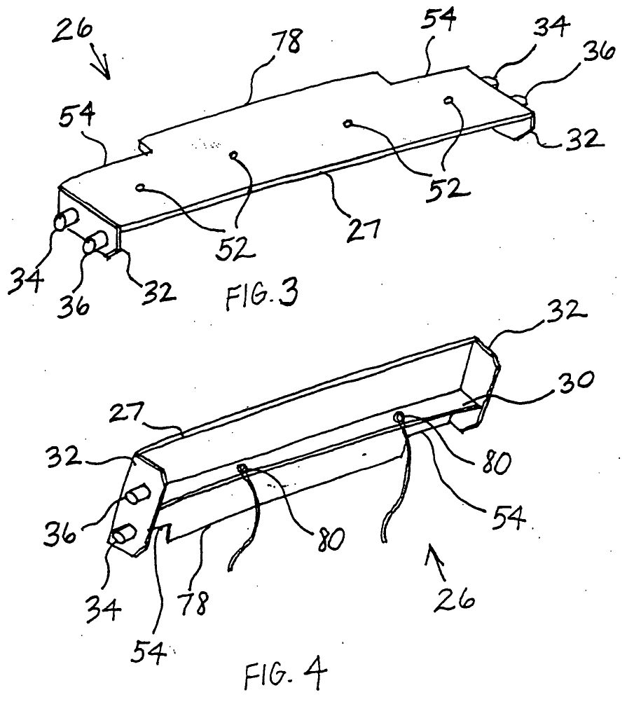

Conveyor discharge member 26, as best illustrated in FIGS. 3 and 4, includes a plate 27 with substantially planar surface 28, a support frame 30, end plates 32 located at each end of the support frame, a first pin 34 and a second pin 36 received on each end plate. Conveyor discharge member 26 is received by a pair of brackets 40 (FIGS. 5-9), which are mounted on a frame 38. Frame 38 is a structure received between first and second conveyor systems 12, 16 (FIGS. 1 and 2). Frame 38 is preferably composed of a metal such as steel, aluminum or any other similar robust material. Frame 38 may be a separate structure or a part of or integrated with the frame or sidewalls of one or both of first and second conveyor systems 12, 16.

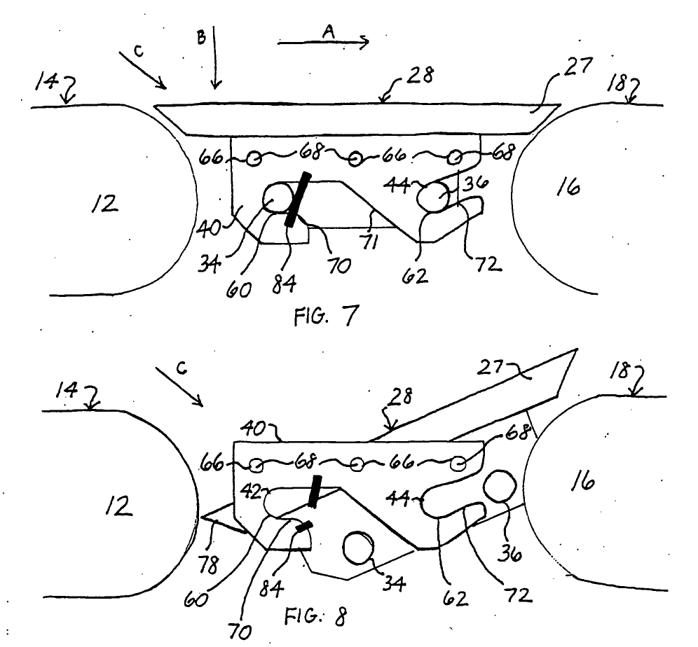

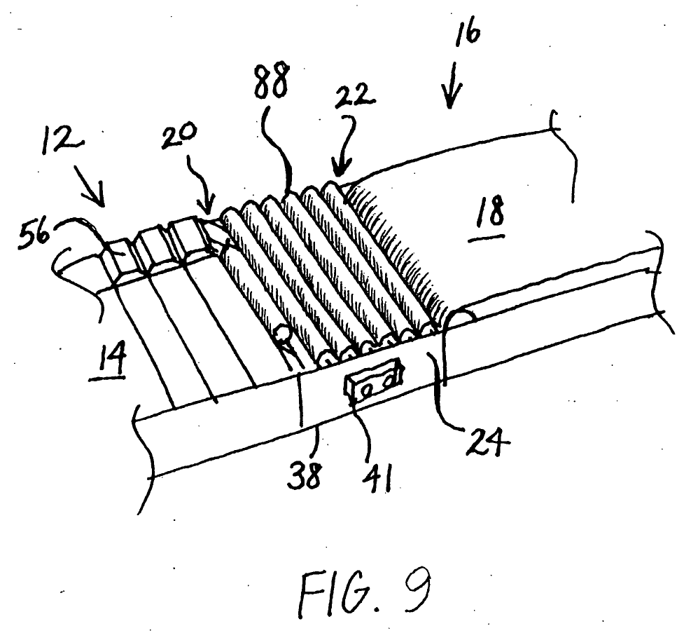

Brackets 40 are received facing each other on opposite internal sides of frame 38. Bracket 40 receives first and second pins 34, 36 to allow conveyor discharge member 26 to be received between first and second conveying surfaces 14, 18 in gap 24. Bracket 40 may be attached to the opposite interval sides of frame 38 with a plate 41 received on the external sides of the frame. Plates 41 may provide additional support when bracket 40 is mounted onto the internal sides of frame 38. Each bracket 40 includes a generally downstream facing first slot 42 and a generally downstream facing second slot 44 receiving first pin 34 and second pin 36, respectively. First and second pins 34, 36 of conveyor discharge member 26 slide or move in slots 42, 44 from a base position (FIGS. 5 and 7) to a dislodged or discharged position (FIGS. 6 and 8). The range of motion or movement or positions of conveyor discharge member 26 will be discussed in further detail below.

Planar surface 28 is the top surface of plate 27. Planar surface 28 is substantially planar with a low coefficient of friction to easily transfer or slide objects being conveyed from first conveying surface 14 to second conveying surface 18. Plate 27 is fastened to support frame 30 with bolts 52 (FIG. 3) or welds. It should be noted that any like mounting means may mount plate 27 onto support frame 30. Planar surface 28 is preferably a polymeric material, but can be composed of any other similar material with a low coefficient of friction, such as other metals like steel or aluminum. In the illustrative embodiments, planar surface 28 includes a pair of notches 54 to compensate or provide clearance for a plurality of sorter shoes 56 of first conveyor system 12, which may be a linear sorter conveyor or a positive displacement sorter conveyor with a slat conveying surface like a Siemens RS-200 Conveying System, such as disclosed in commonly assigned U.S. Pat. No. 5,127,150, the disclosure of which is hereby incorporated herein by reference, or any other similar sorter conveyor.

Support frame 30, end plates 32, first pins 34 and second pins 36 form a robust structure providing support for plate 27 as the pins are placed in bracket 40. Bracket 40 includes a preferably block-like body with first slot 42, second slot 44 and apertures 66 therethrough. Apertures 66 may receive bolts 68 for mounting bracket 40 onto frame 38. First slot 42 includes a first base portion 60 and a first opening portion 70. Second slot 44 includes a second base portion 62 and a second opening portion 72.

When first and second pins 34, 36 are fully received into first and second base portions 60, 62 of first and second slots 42, 44, conveyor discharge member 26 is in the base position, as illustrated in FIGS. 1 and 5. In this base position, first and second pins 34, 36 on each end plate 32 are seated or engaged or secured in first and second base portions 60, 62 of bracket 40 and conveyor discharge member 26 is able to support a substantial vertical load or force B, such as the weight of a person, applied generally perpendicular to planar surface 28 without displacing or bending or deforming by the conveyor discharge member. In this base position, the substantial vertical load or force B may be applied substantially perpendicular to surface 28 and conveyor discharge member 26 will not move or displace from this base position due to first and second base portions 60, 62 securing or supporting or holding pins 34, 36 in the base position. First and second base portions 60, 62 may include a detent, notch, ridge, or slight arc to help support or hold or secure first and second pins 34, 36 in the base position. Thus, conveyor discharge member 26 is able to withstand a vertical load B substantially greater than a particular longitudinal load C in the base position since first and second base portions 60, 62 of slots 42, 44 stabilize and support pins 34, 36 of the conveyor discharge member when a substantially vertical load B is applied.

When generally longitudinal force C is applied generally to conveyor discharge member 26, such as to a leading edge 78 of planar surface 28, first pin 34 will be urged or forced out of first base portion 60 and slide or move into first opening portion 70 while second pin 36 is also urged or forced out second base portion 62 and slide or move into second opening portion 72, thus moving or sliding conveyor discharge member 26 into the dislodged or discharged position while avoiding adjacent conveying systems 12, 16 as best illustrated in FIG. 6. When the particular longitudinal load C is applied onto conveyor discharge member 26, first and second base portions 60, 62 of slots 42, 44 do not offer or provide longitudinal support in the downstream direction of conveying, A, and thus pins 34, 36 slide or move in the direction of conveying out of the portions of the slots. First opening portion 70 may include a downward angled portion 71 which urges leading edge 78 of planar surface 28 downward when first pin 34 is urged or forced out of first base portion 60. Second opening 72 may be angled slightly upward in order to urge leading edge 78 downward as to prevent contact with either first conveying surface 14 or second conveying surface 18. Longitudinal force C may originate from conveyed objects or from items protruding from such conveyed objects. If generally longitudinal force C is great or continuously applied, conveyor discharge member 26 eventually completely dislodges or discharges or breaks away from brackets 40 and the conveyor discharge member may be caught by at least one tether 80, which may be connected to frame support 30 and frame 38. Tether 80 catches conveyor discharge member 26 when it fully discharges, dislodges, or breaks away from brackets 40. In another form of the present invention, tether 80 may be connected to some form of alarm or sensor to notify a technician or user of the dislodging or discharging or breaking away of conveyor discharge member 26 from brackets 40.

Support frame 30, end plates 32, first pins 34, second pin 36 and bracket 40 are preferably composed of a metal, such as steel, aluminum or the like but can be any material like a polymeric composite that is robust enough to withstand a substantial vertical load upon planar surface 28. End plates 32 are preferably welded onto support frame 30, but also may be bolted on. First pin 34 and second pin 36 are preferably welded onto end plate 22 but also may be bolted on. First pin 34 and second pin 36 are preferably round, cylindrical or peg-like in shape, to be easily received in and out of slots 42, 44 of bracket 40.

A set of sensors 82, as shown in FIGS. 1 and 2, may be installed and positioned in or substantially proximate to slots 42, 44 of brackets 40 to monitor or sense any displacement of first and second pins 34, 36 relative to the first and second slots. Sensors 82 may be any mass sensor or the like that is well known in the art, and may be mounted or received on the external side of frame 38, as illustrated in FIGS. 1 and 2. Sensors 82 would monitor displacement of first and second pins 34, 36 to notify users and/or adjust operating parameters for conveyors 12, 16. For example, when conveyor discharge member 26 is in the base position, optional sensors 82 will identify this state and do nothing. If the generally longitudinal force C is applied upon conveyor discharge member 26 to displace first and second pins 34, 36 from first and second slots 42, 44 to slide or move the conveyor discharge member into the dislodged or discharged position, sensors 82 will identify this condition or state or position and may slow down the speed of first conveyor system 12 or stop it completely. If the generally longitudinal force C is great enough or continuous to completely dislodge, discharge or break away conveyor discharge member 26 from brackets 40, sensors 82 will identify this condition or state or position and shut down first conveying surface 14 to prevent damage to first and second conveyors 12, 16 or the conveyor discharge member. Additionally, optional sensors 82 may notify users of jams or dislodging or discharging or breaking away of conveyor discharge member 26 in order to place the conveyor discharge member back to the base position. It should also be appreciated that sensors 82 may be placed in a multiple of configurations. For example, sensor 82 may be placed in first slot 42, in second slot 44 or both. Additionally, plurality of sensors 82 may be placed along each slot 42, 44 to obtain a more precise location, position or orientation of conveyor discharge member 26. For example, sensors 82 may be placed in first and second base portions 60, 62, and first and second openings 70, 72 to provide a more precise reading of the position or orientation or state or condition of conveyor discharge member 26.

In an alternative embodiment of the present invention, a retainer 84 or shear pin or shear device or shear retainer or similar element, which in the illustrative embodiment is a plastic bolt, may be inserted into first slot 42 of bracket 40 to secure first pin 34 in the base position (FIG. 8). Retainer 84 may be a shear pin that will break, as shown in FIG. 9, when the generally longitudinal force C exceeds a threshold breaking point of the pin member when applied onto conveyor discharge member 26. When retainer 84 or equivalent element breaks, conveyor discharge member 26 operates in a similar fashion or manner as described above, by moving into the discharge or dislodge position, if generally longitudinal force C is great enough or continuous. However, retainer 84 will not break if substantial vertical load B is applied onto conveyor discharge member 26, thus the conveyor discharge member supports vertical load B substantially greater than generally longitudinal load C. It should be noted pin members 84 or equivalent element may also be placed in both or either of first or second slots 42, 44 or any combination thereof, while still keeping within the spirit and scope of the present invention.

In another embodiment of the present invention of FIG. 9, substantially planar surface 28 may comprise a plurality of rollers 88 or wheels or balls, or the like, while keeping with the scope and spirit of the present invention. Rollers 80, wheels or balls would allow conveyed objects to transition between first and second conveying surfaces 14, 18 and operate in a similar manner or fashion as planar surface 28 provided above.

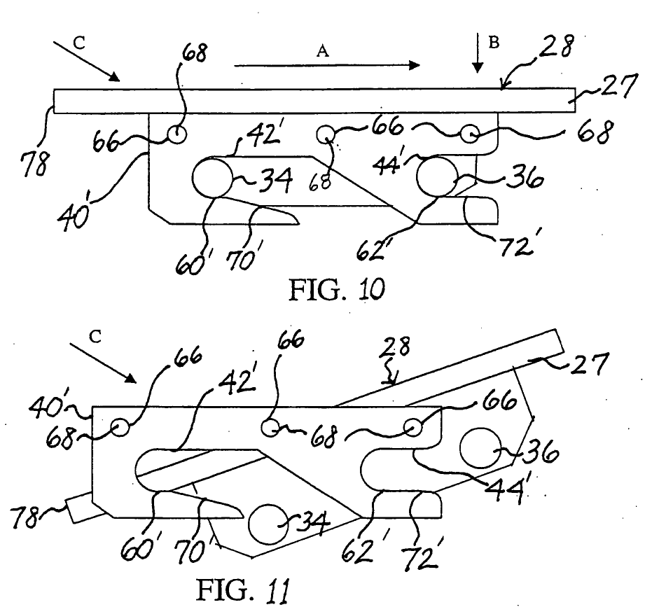

In yet another embodiment of the present invention in FIGS. 10 and 11, brackets 40′ include a generally downstream facing first slot 42′ and a generally downstream facing second slot 44′ receiving first pin 34 and second pin 36, respectively. First and second pins 34, 36 of conveyor discharge member 26 slide or move in slots 42′, 44′ from a base position as illustrated in FIG. 10. First slot 42′ includes a first base portion 60′ and a generally downward angled portion 70′. Second slot 44′ includes a second base portion 62′ and a second opening 72′. In the base position, first and second pins 34, 36 on each end plate 32 are seated or engaged or secured in first and second base portions 60′, 62′ of bracket 40′. Conveyor discharge member 26 is able to support a substantial vertical load or force applied generally perpendicular to planar surface 28 without displacing or bending or deforming the conveyor discharge member in the base position. When a generally longitudinal force C is applied to conveyor discharge member 26, first pin 34 will be urged or forced out of first base portion 60′ and slide or move into downward angled portion 70′ while second pin 36 is also urged or forced out of second base portion 62′ to slide or move out of second opening 72′, thus moving or sliding conveyor discharge member 26 into the dislodged or discharged position while avoiding adjacent conveying systems 12, 16, as best illustrated in FIG. 11. Downward angle portion 70′ urges leading edge 78 of surface 28 downward to avoid contact between conveyor discharge member 26 and conveying systems 12, 16.

In yet another embodiment of the present invention, a pair of brackets may include a first pin and a second pin engaging a first generally upstream facing slot and a second generally upstream facing slot of a conveyor discharge member, while keeping within the spirit and scope of the present invention. The first and second pins of the brackets may slide or move in the slots to dislodge when a generally longitudinal force C is applied to the conveyor discharge member. The slots are generally upstream facing to avoid contact with the adjacent conveying systems 12, 16 when the conveyor discharge member dislodges. Additionally, when the first and second pins of the brackets are engaged or secured in the slots of the conveyor discharge member, the conveyor discharge member can withstand a substantial vertical force or load.

While the preferred embodiment of the present invention is described above, it is contemplated that variations will be developed within the teaching of the present disclosure. Changes and modifications to this specifically described embodiment may be carried out without departing from the principles of the present invention, which is intended to be limited only by the scope of the appended claims as interpreted according to the principles of patent law.

We claim:

1. A conveyor system comprising:
first and second conveying surfaces conveying objects in a longitudinal direction, said first and second conveying surfaces defining a gap at a transition between said first and second conveying surfaces; and
a conveyor discharge member at said gap, said conveyor discharge member comprising a plate, said plate defining a generally planar surface between said first and second conveying surfaces;
wherein said conveyor discharge member is movable in response to a particular generally longitudinal force to reduce jam locations between said conveyor discharge member and said first and second conveying surfaces.

2. The conveyor system of claim 1, wherein said planar surface comprising a low-friction material.

3. The conveyor system of claim 2, wherein said low-friction material comprising a polymeric material or a metal material.

4. The conveyor system of claim 1, wherein said conveyor discharge member further comprising a support operable for supporting said plate.

5. The conveyor system of claim 4 further comprising at least one tether attached to said conveyor discharge member, said at least one tether operable for retaining said conveyor discharge member when said conveyor discharge member is moved.

6. The conveyor system of claim 1, further comprising a first pin and a second pin extending laterally on each of the opposite ends of one chosen from said conveyor discharge member and a frame received in said gap, said first and second pins adapted to be received by the other chosen from said conveyor discharge member and said frame, and supporting said conveyor discharge member.

7. The conveyor system of claim 6 further comprising a pair of brackets received by said frame between said first and second tandem conveying surfaces, said brackets operable for receiving and supporting said conveyor discharge member.

8. The conveyor system of claim 7, wherein each said brackets comprises first and second generally downstream facing slots, said first and second slots operable for receiving and engaging said conveyor discharge member.

9. The conveyor system of claim 8, wherein each said first and second generally downstream facing slots comprising first and second lateral portions, said first and second lateral portions operable for engaging and securing said first and second pins of said conveyor discharge member into a base position, said first and second lateral portions supporting a vertical load greater than a particular generally longitudinal load applied on said conveyor discharge member in said base position.

10. The conveyor system of claim 9, said first generally downstream facing slot further comprising a first opening portion and said second generally downstream facing slot further comprising a second opening portion;
wherein said first and second pins pass said first and second opening portion to dislodge said first and second pins from said brackets into a dislodged position where said particular longitudinal load is applied on said conveyor discharge member.

11. The conveyor system of claim 8 further comprising at least one retainer adapted to securing at least one of said pins;
wherein said retainer releases said at least one of said pins when a predetermined longitudinal load is applied upon said conveyor discharge member.

12. The conveyor system of claim 8 further comprising at least one sensor, wherein said at least one sensor adapted to detecting displacement of said conveyor discharge member from said brackets.

13. A conveyor system comprising:
first and second conveying surfaces conveying objects in a longitudinal direction, said first and second conveying surfaces defining a gap at a transition between said first and second conveying surfaces; and
a conveyor discharge member at said gap, said conveyor discharge member comprising a plate, said plate defining a generally planar surface between said first and second conveying surfaces;
wherein said conveyor discharge member adapted to support a particular vertical load, wherein said conveyor discharge member is adapted to be displaced in response to a particular generally longitudinal load, wherein said particular vertical load is greater than said particular generally longitudinal load.

14. The conveyor system of claim 13, wherein said generally planar surface comprising a low-friction material.

15. The conveyor system of claim 14, wherein said low-friction material comprising a polymeric material or a metal material.

16. The conveyor system of claim 13 further comprising at least one tether attached to said conveyor discharge member, said at least one tether operable for retaining said conveyor discharge member when said conveyor discharge member is moved.

17. The conveyor system of claim 13, further comprising a first pin and a second pin extending laterally on each of the opposite ends of one chosen from said conveyor discharge member and a frame in said gap, said first and second pins adapted to be received by other chosen from said conveyor discharge member and said frame, and supporting said conveyor discharge member.

18. The conveyor system of claim 13 further comprising a pair of brackets received by said frame between said first and second conveying surfaces, said brackets operable for receiving and supporting said conveyor discharge member.

19. The conveyor system of claim 18, wherein each said bracket comprising first and second generally downstream facing slots, said first and second slots operable for receiving and engaging said first and second pins of said conveyor discharge member.

20. The conveyor system of claim 13, further comprising:
a pair of brackets received by a frame in said gap, said bracket including first and second generally downstream facing slots comprising first and second base portions, said first and second base portions defining generally horizontal surfaces operable for securing first and second pins of said conveyor discharge member to support a vertical load on said conveyor discharge member.

21. The conveyor system of claim 19 further comprising at least one retainer adapted to securing at least one of said pins;
wherein said retainer releases said at least one of said pins when a predetermined longitudinal load is applied upon said conveyor discharge member.

22. The conveyor system of claim 19 further comprising at least one sensor received in at least one of said first and second generally downstream facing slots;
wherein said at least one sensor operable for detecting displacement of said first and second pins within said first and second slots.

23. A method for reducing object jams between first and second conveying surfaces comprising:
positioning a conveyor discharge member between the first and second conveying surfaces, the conveyor discharge member providing a planar surface between the first conveying surface and second conveying surface; and
supporting the conveyor discharge member to be dislodged from between the first and second conveying surfaces in response to a particular generally longitudinal load applied to the conveyor discharge member.

24. The method of claim 23, further comprising:
supporting the conveyor discharge member to support a vertical load substantially greater than the particular generally longitudinal load.
